(19) United States
(12) Patent Application Publication
(10) Pub. No.: US 2011/0082254 A1
(43) Pub. Date: Apr. 7, 2011

(54) METHOD FOR THE PRODUCTION OF A HIGHLY ABRASION-RESISTANT VEHICLE PAINT, VEHICLE PAINT, AND THE USE THEREOF

(75) Inventors: Stefan Sepeur, Wadgassen (DE); Nora Laryea, Saarbruecken (DE); Carolin Thurn, Heusweiler (DE); Gerd Schlick, Freyming-Merlebach (DE)

(73) Assignee: NANO-X GmbH, Saarbruecken (DE)

(21) Appl. No.: 12/736,181

(22) PCT Filed: Mar. 18, 2009
(86) PCT No.: PCT/DE2009/000351

§ 371 Date: Dec. 3, 2010

(30) Foreign Application Priority Data
Mar. 18, 2008 (DE) 10 2008 014 717.6

(51) Int. Cl. B05D 5/00; B05D 3/02; B05D 3/06; C09D 183/00

(52) U.S. Cl. 524/588; 427/387; 427/294; 427/295; 427/296; 427/510; 427/515

(57) ABSTRACT

The invention relates to a method for the production of a highly abrasion-resistant vehicle paint, vehicle paint, and the use thereof.

In order to create a vehicle paint having extremely high scratch and chemical resistance, particularly for use in multi-layer coating for OEM series coating (particularly as a clear coat or base cast), the invention proposes a method for the production of a highly abrasion-resistant vehicle paint, comprising the following steps:
a. Providing at least one organic monomer, oligomer, prepolymer, or organosilane having one or more organic functional groups, or mixtures thereof;
b. Saturating the functional groups described in a. by reacting them with silanes having organic side chains that contain one or more corresponding functional groups, the resultant silane having at least six SiOR groups and a molecular weight exceeding 300;
c. Absorbing the resultant macro-molecular silanes in solvent, preferably protic or aprotic solvent, or mixtures thereof;
d. Adding reaction partners, particularly acids, Lewis acids, bases or Lewis bases;
e. Applying the vehicle paint obtained in this manner onto a substrate, and
f. Curing the coating material.

The invention relates to a method for the production of a highly abrasion-resistant vehicle paint, vehicle paint, and the use thereof.

Known silane coatings exist which are produced from silicone resins. These involve pre-condensing monomers, such as dimethyl siloxane or otherwise organically modified homologous species, until resins of high molecular weight are obtained. These can then be cured with the usual commercial starters. Applications of such systems include coating, building protective agents, sealants, etc.

To maintain these systems in a form suitable for coating purposes, and to prevent gelation, silanes with two organically modified side chains are generally utilized. These coating systems are highly temperature resistant, but usually demonstrate only moderate abrasion resistance.

Three- and fourfold cross-linkable silanes are made into a processable form in the sol-gel process. In this process, silanes such as tetraethoxysilane (TEOS) or methyltriethoxysilane (MTEOS), but also organically modified silanes such as glycidoxypropyltriethoxysilane (GPTES, Glyeo) or methacrylpropyltrimethoxysilane (MPTS) etc., are hydrolysed with water and pre-condensed in the presence of a catalyst. This creates a sol suitable for coating purposes, which, following application and curing, can be applied to a surface as coating.

This results in additional organic linking, the coatings being generally scratchproof as well as densely cross-linked and resistant to chemicals.

However, low-molecular alcohols such as methanol and ethanol are created during the synthesis, which exhibit a low flash point and are difficult to remove. These may be removed with a rotary evaporator, as described in DE 198 16 136 A1, or by means of phase separation, as described in DE 100 63 519 A1. The limited pot life resulting from uncontrolled continuation of the condensation reactions remains a problem.

WO 2006/042658 A1, by way of example, describes scratchproof, highly elastomeric coating agents for topcoats, especially clearcoats, for OEM series coating. Obtained by reacting isocyanates (HDI) with aminofunctional silanes, the silane compositions are cross-linked by means of appropriate catalysts, for example.

However, they can only be dissolved in aprotic solvents or aprotic solvent mixtures. EP 540 884 A1 describes a process for making free-radical and/or cationnically polymerisable, silicone-containing clearcoats for multi-layer coatings. These clearcoats are dried under UV light. They are described as showing good scratch resistance, but detailed information on their scratch resistance is not given.

EP 468 967 A1 describes a process for making for OEM series coating using radiation-curing clearcoats. However, to obtain clearcoat films with a sufficiently high optical quality, it is necessary first to apply a heat-curing clearcoat and then a radiation-curing clearcoat.

DE 101 52 853 A1 describes a heat-curing coating composition comprising an epoxy silane which is pre-hydrolysed and then reacted with a blocked isocyanate. Aprotic solvents are used. The main use of the composition is described as being an easy-to-clean coating for metals. The curing temperature is determined by the deblocking temperature (<100° C.) of the organic isocyanate components. No information is provided concerning the scratch resistance.

EP 675 087 A1 also describes a coating composition comprising epoxy silane (hydrolysed), silica sol, dimethyldimethoxysilane and fluorinated silane, which is used, for example, as a hydrophobic, oleophobic and abrasion-resistant coating for glass. The abrasion resistance of the films is not specified in detail. Use of the coating composition for automobile series coating is doubtful, especially with respect to over-paintability and repair suitability, on account of the fluorine component. The applied film thicknesses of 0.1-10 μm are outside the usual topcoat range in series coating.

DE 10 2004 050 747 A1 describes an overview of a wide variety of prior art patents. The formulations described are limited to use in OEM coating, but tough requirements concerning scratch resistance, resistance to chemicals and weathering stability are not fulfilled.

Moreover, scratchproof coating materials are often densely cross-linked, which means their shelf lives are not particularly long, or they cross-link incompletely, or are insufficiently flexible and thus prone to crack formation when applied in the required film thicknesses of >20 μm or >40 μm.

The object of the invention is thus to provide a vehicle paint having extremely high scratch and chemical resistance, particularly for use in multi-layer coating for OEM series coating (particularly as clearcoat or basecoat), which is far superior to the prior art in respect of scratch resistance (high car-wash resistance) and resistance to chemicals (resistance to acids and bases) without other qualities that have to be fulfilled for series coating being impaired. Such requirements include, for example:
Very long shelf life of the coating formulation
Good polishing quality
Suitable for sanding with commercially available abrasives
Repairable
Resistance to stone-chipping
Spot-repair suitability
Suitable for bonding without additional processes, such as masking or priming
Good weathering resistance
High gloss level
Pleasing appearance
Application of film thicknesses generally >20 μm without impairment of flexibility
Baking temperatures of around 80° C. (e.g. for coating plastics and for repair coating) and 160° C. (for series coating)
Resistance to bird droppings and tree resin
Resistance to fuel

A further object of this invention is to develop a process for producing extremely scratchproof formulations that are suitable for OEM series coating without impairing other required properties of the paint films. The coating agents used in this process should also have a long shelf life (at least 8 weeks when stored at 50° C.) and result in coatings which not only show high scratch resistance but also high resistance to chemicals, good resistance to moisture and good polishing quality. In addition, these coating agents should be suitable for use as clearcoats and/or topcoats in the production of multi-layer coating systems, especially in the automotive sector. The cured formulations should have good weathering resistance, good resistance to acids and bases, good resistance to bird droppings and the like, a high gloss level and a pleasing appearance.

The coating formulations for OEM series coating should be suitable for use both as topcoat (for the application of so-called base and clear systems (two-coat paint finish) comprising a coloured basecoat and, on top of that, a clearcoat applied wet-on-wet as 4^{th} or 5^{th} layer) or as basecoat applied as the 3^{rd} layer with the appropriate pigmentation (e.g. also as 2^{nd}-layer body-filler substitute), or for use as one-coat paint finish (pigmented topcoat).

This object is established according to the invention by a method for producing a highly abrasion-resistant vehicle paint, comprising the following steps:
a. Providing at least one organic monomer, oligomer, prepolymer, or organosilane having one or more organic functional groups, or mixtures thereof;
b. Saturating the functional groups described in a. by reacting them with silanes having organic side chains that contain one or more corresponding functional groups, the resultant silane having at least six SiOR groups and a molecular weight exceeding 300;
c. Absorbing the resultant macro-molecular silanes in solvent, preferably protic or aprotic solvent, or mixtures thereof;
d. Adding reaction partners, particularly acids, Lewis acids, bases or Lewis bases;
e. Applying the vehicle paint obtained in this manner onto a substrate, and
f. Curing the coating material.

Surprisingly, it was found that especially the reaction of mixtures of NCO-functionalized silanes and aliphatic isocyanates with mixtures of long-chain diols and OH-group-containing polyols (in particular polyacrylates) leads to urethane-functionalized silanes that can subsequently be cross-linked with protic and/or aprotic solvents, UV absorbers, light stabilizers (HALS), flow improvers and antifoaming agents or with catalysts, preferably in the form of complexed acids or metal complexes. It was found that the reaction with organic or inorganic OH-functional UV absorbers leads to permanent incorporation of these into the binder, imparting greater stability to the formulations and preventing any exudation or “sweating”. The extremely scratch- and abrasion-resistant coating formulations obtained in this way fulfil the requirements listed above and are particularly suitable as topcoats in OEM series coating. These may be overpainted onto commercially employed clearcoats or powder coats (5^{th} layer), applied as topcoat directly wet-on-wet onto commercially employed aqueous and solvent-borne basecoats (4^{th} layer), or, following pigment addition, applied directly onto the CDP layer as pigmented topcoat to substitute for basecoat and/or body filler (3^{rd} and 2^{nd} layer).

The scope of the invention also includes a method for the production of a highly abrasion-resistant vehicle paint, characterised by the following steps:
a. Providing at least one organic monomer, oligomer, prepolymer, or organosilane having one or more organic functional groups, or mixtures thereof;
b. Saturating the functional groups described in a. by reacting them with silanes having organic side chains that contain one or more corresponding functional groups, the resultant silane having at least six SiOR groups and a molecular weight exceeding 300;
c. Adding additives to the macromolecular silanes formed;
d. Processing the product as powder clearcoat.

The high-molecular silanes produced can also be obtained as solids, and, following addition of additives, these can be processed further as powder clearcoat (by melting). Obviously, the powder can also be dissolved in a suitable solvent and then processed further.

According to the invention, the organic functional groups are amino, hydroxyl, epoxy, mercaptan, carboxylic acid, anhydride, oxime, isocyanate, thioisocyanate, methacryl, acryl or vinyl groups.

It is to advantage that, for a stoichiometric reaction, the corresponding groups are, in particular, hydroxyl and isocyanate, isocyanate and amino, carboxylic acid and isocyanate, carboxylic acid and hydroxyl, anhydride and isocyanate, epoxy and amine, isocyanate and epoxy, hydroxyl and epoxy.

In a further embodiment of the invention, the corresponding groups may contain unsaturated carbon-carbon bonds (C═C double bonds, C≡C triple bonds). Accordingly, the organic functional groups of the organic monomer, oligomer, prepolymer or organosilane may also be, for example, acrylate, methacrylate or vinyl groups. Silanes with organic side-chains containing unsaturated C—C bonds may be used to react with these groups. Such silanes include, for example, methacryloxpropyltrimethoxysilane, acryloxpropyltrimethoxysilane, vinyltrimethoxysilane or the corresponding ethoxy or acetoxy variants of these silanes. Polymerisation either takes place at room temperature or is induced by means of heat or actinic radiation (e.g. UV radiation). Temperature-induced polymerisation of the organic compounds and silanes mentioned is effected with free-radical or ionic starters that are known from the prior art. Among these are inorganic or organic peroxide compounds, such as cyclohexylperoxydicarbonate (CHPC) or dicumylperoxide, and azo compounds, such as azo-bis-isobutyronitrile (AIBN). The functional and corresponding unsaturated C—C bonds may also be effected by subjecting the reaction mixture to UV radiation in a suitable reaction vessel. Typical radiation-sensitive substances (reaction initiators) such as 1-hydroxy-cyclohexyl-phenyl-ketone or other commercial products may be used as UV initiators.

It is accordingly within the scope of the invention that, for a free-radical reaction, the functional and corresponding groups are in each case unsaturated carbon-carbon bonds, in particular acrylate, methacrylate or vinyl groups with unsaturated carbon-carbon double bonds. Carbon-carbon double bonds as well as carbon-carbon triple bonds or mixtures thereof may thus be present.

It is furthermore to advantage that the monomers, oligomers or prepolymers are functionalized hydrocarbons, fluorinated hydrocarbons, polyesters, polyethers, polyurethanes, polyamides, polyanilines, polyimides, polyphenols, polysulfamides, imide, polyacrylate, polyurethane acrylate, polyester acrylate, thiols, polyether acrylates, polyester acrylates, aminofunctional acrylates, phenols, phenol resins, melamine or methacrylates.

According to an embodiment of the invention, pigments are added prior to application of the vehicle paint.

Besides the production of clearcoats, the formulations may also be pigmented. Surprisingly, the inorganic surface functionalization causes the pigments to be firmly incorporated into the binder and stabilized, eliminating the risk of chalking (e.g. as a result of ageing or abrasion).

It is within the scope of the first embodiment of the invention that, prior to application of the vehicle paint, organic or inorganic UV absorbers, dulling agents, wetting or dispersing agents, HALS stabilizers, free-radical scavengers, antifoaming agents, waxes, biocides, preserving agents, inorganic or organic fillers, fluorinated carbon particles or waxes are added.

According to the second embodiment of the invention, organic or inorganic UV absorbers, dulling agents, wetting or dispersing agents, HALS stabilizers, free-radical scavengers, antifoaming agents, waxes, biocides, preserving agents, inorganic or organic fillers, fluorinated carbon particles or waxes are added as additives in step c.

The invention provides for the molecular weight of the silane(s) to be greater than 300, preferably greater than 500 and most preferably greater than 1,000.

The following silanes are particularly suitable: 3-acryloxypropylmethoxysilane, 3-acryloxypropyltriethoxysilane, 3-aminopropyltriethoxysilane, aminoethylaminpropyltrimethoxysilane, aminoethylaminopropyltrimethoxysilane, aminoethylaminopropylsilane, 3-aminopropyltrimethoxysilane, N-(2-aminoethyl)-3-aminopropyltrimethoxysilane, N-(2-aminoethyl)-3-aminopropylmethyldimethoxysilane, N-(2-aminoethyl)-3-aminopropylmethyldimethoxysilane, N-cyclohexyl-3-aminopropyltrimethoxysilane, benzyl-aminoethylaminopropyltrimethoxysilane, vinylbenzylaminoethylaminopropyl-trimethoxy-silane, vinyltrimethoxysilane, vinyltriethoxysilane, vinyldimethoxymethylsilane, vinyl(tris)methoxyethoxy)silane, vinylmethoxymethylsilane, vinyltris(2-methoxyethoxy)silane, vinyltriacetoxysilane, chloropropyltrimethoxysilane, 3-glycidoxypropyltrimethoxysilane, 3-glycidoxypropyltriethoxysilane glycidoxypropylmethyldiethoxysilane, mercaptopropyl-trimethoxysilane, bis-triethoxysilylpropyldisulfidosilane, bis-triethoxysilyl-propyl-disulfidosilane, bis-triethoxysilylpropyltetroasulfidosilane, N-cyclohexyl-amino-methylmethyldieethoxysilane, N-cyclohexylaminomethyltriethoxysilane, N-phenylaminomethyltrimethoxysilane, (methacryloxymethyl)methyldimethoxysilane, methacryl-oxymethyltrimethoxysilane, (methacryloxymethyl)methyldiethoxysilane, methacryloxymethyl-triethoxysilane, 3-methacryloxypropyltrimethoxysilane, 3-mercaptopropylmethyldimethoxysilane, 3-methacryloxypropyltrimethoxysilane, 3-methacryloxypropyltriacetoxysilane, (isocyanatomethyl)methyldimethoxysilane, 3-isocyanato-propyltrimethoxysilane, 3-isocyanatopropyltriethoxysilane, 3-trimethoxy-silylmethyl-O-methylcarbamate, N-dimethoxy-(methyl)silylmethyl-O-methyl-carbamate, 3-(triethoxysilyl)propylsuccinic acid anhydride, dicyclopentyldimethoxysilane and 3-(trimethoxysilyl)propyldimethyloctadecylammoniumchloride, tris(3-trimethoxysilyl)-isocyanurate, 3-triethoxysilylpropyl)-t-butylcarbamate, triethoxysilyl-propylethylcarbamate, 3-thiocyanatopropyltriethoxysilane, bis[3-(triethoxysilyl)propyl]-tetrasulfide, bis[3-(triethoxysilyl)propyl]-disulfide, beta-(3,4-epoxycyclohexyl)ethyltriethoxysilane.

A development of the invention consists in that the silane(s) have polarised groups in organic side-chains, said groups being suitable for the formation of hydrogen bridge bonds.

It is also within the scope of the invention that the vapour pressure of the silane(s) is less than 2, preferably less than 1 and most preferably less than 0.5 hPa at 20° C.

It is furthermore within the scope of the invention that, prior to curing, the silane(s) undergo(es) an organic crosslinking reaction with homologous or non-homologous silanes or with organic monomers, oligomers or polymers.

It is to advantage in this connection that the organic molecular weight is greater than the inorganic.

It proved to be advantageous if the water content in steps a.) to c.) does not exceed 5%, preferably does not exceed 1%, the reaction most preferably being carried out in the absence of water.

According to the invention, the silane(s) are inorganically pre-crosslinked to a maximum extent of 5%, preferably to a maximum extent of 1% and most preferably not at all.

It is furthermore to advantage that up to 20%, preferably 0.5 to 50%, Lewis acids or Lewis bases are used as reaction partners, especially in the form of complexes or salts of transition metals, or of transition-metal particles, preferably micro- or nanoparticles.

It is preferable if the complexes, salts or particles of transition metals are complexes of titanium, aluminium, tin or zirconium.

A development of the invention consists in that particles, in particular micro-, submicro- or nanoparticles, are added as fillers.

It is also within the scope of the invention that, as solvent in step c., alcohols, acetates, ethers, low-molecular silanes or metal alkoxides, in particular zirconium butylate, aluminium butylate or titanium butylate are used as reactive thinner

The invention furthermore provides that the coating material is applied to a substrate by a wet-chemical process, in particular by spraying, dipping, flooding, rolling, painting, printing, spinning, knife application or otherwise by vacuum evaporation.

It is also within the scope of the invention that the coating material is applied to a substrate by powder coating.

It is possible both to apply the coating material onto a system as is customarily used in the automotive industry, comprising CDP layer, body filler and basecoat, or to apply the coating directly onto a coloured body filler. In addition, the coating material may be used as primer, basecoat or clearcoat for painting on plastics, and it may also be used as an additive for standard clearcoats.

In this context, the invention provides for the substrate to consist of metal, plastics, ceramics, paint, rubber, glass or composite materials.

It is expedient that, following application, the coating material is cured at temperatures ranging from room temperature to 1,200° C., preferably from room temperature to 250° C., curing being effected preferably by heat, microwave radiation or UV radiation.

The scope of the invention also includes a vehicle paint produced by a method according to the invention, and use of the vehicle paint according to the invention as clearcoat (topcoat), pigmented coat (basecoat), body-filler coat, repair coat or powder coat for vehicle bodies, in particular automobile or motorcycle bodies, vehicle parts, in particular automobile and motorcycle parts, and also fitted parts, attachments, accessories and spare parts for vehicles, in particular rims, bumpers, covers or decorative trim. Vehicles in this context refer to land and water vehicles and aircraft, in particular cars and lorries, buses, motorcycles, rail-bound vehicles, ships and aeroplanes.

The vehicle paint according to the invention may thus be used as the 2^{nd}, 3^{rd}, 4^{th} or 5^{th} layer within the paint system, and is suitable for parts made of metal, plastics or other materials.

Alternatively, the coating material according to the invention may also be used as an additive to commercial clearcoat systems.

The invention is described below in detail by reference to embodiments:

### EXAMPLE 1

87 g Setalux 1187 XX 60 (Akzo Nobel) are introduced into a 11 Schott flask together with Setalux 1196 XX 60 (Akzo Nobel), 91.9 g 1,6 hexanediol (Fluka) and 8.62 g TINUVIN 405 (Ciba) and heated on a heater stirrer with simultaneous stirring until a clear solution forms (approx. 80° C.).

Then approx. 4 drops of dibutyltindilaurate catalyst are added.

A previously mixed solution of 32.6 g Desmodur N 100 and 87.05 g 3-ICTMS (isocyanatopropyltrimethoxysilane, Onichem) is then stirred in. After the reaction has subsided, 87.05 g ICTMS are added. After it has cooled to approx. 60° C., the reaction mixture is diluted with 243.7 g butylglycol (Fluka). Then 13.9 g TINUVIN 152 (50% in pentyl acetate), 13.9 g TINUVIN 292 (50% in pentylacetate), 2 g Byk 301 (Byk Chemie), 0.832 g Tego Flow 370 (Tego) and 0.832 g Byk 088 (Byk Chemie) are added to the formulation.

### Use 1 (Clearcoat, Topcoat for OEM Coating):

To prepare a highly abrasion- and scratch-resistant clearcoat formulation, 16.7 g of Nacure 4575 cross-linking catalyst are added to the above-described mixture.

The formulation is subsequently coated wet-on-wet onto a steel sheet by spraying onto an aqueous basecoat (black) and dried for 20 minutes at 135° C. The overall paint system is as follows: steel sheet/CDP/body filler/basecoat/clearcoat (topcoat).

### Coating Film Properties:

The abrasion resistance was determined with an abrasion tester for washability and scrub resistance (Erichsen), using the tester's abrasive hand pad (3M Scotch Brite Nr. 7448) as abrasive medium. To assess the abrasion resistance, the gloss levels of the coated and uncoated sides of the metal sheet were compared with each other before and after load 500 cycles. After the test, the uncoated side is visibly very badly scratched. To quantify the abrasion resistance, the remaining gloss was determined as a percentage of the initial gloss on each of the surfaces. The measurement showed that the coated surface had no notable decrease in gloss. The coating also proved to be highly resistant to chemicals, and its appearance was excellent. These films can also be polished. The resistance to chemicals was tested as follows:

The test sheet was heated to different temperatures (depending on the test substance) in a gradient oven. Various test substances were then dripped onto the sheet. After 30 minutes, the specimens were cleaned under running water and dried. Changes were evaluated after 24 hours' storage. The specimens were cleaned again, this time with ethanol, and dried prior to evaluation.

| Test substance | Test temperature | Appearance of the surfaces |
|---|---|---|
| 36% sulphuric acid | 65° C. | No change |
| Diesel fuel | RT | No change |
| 1% sulphuric acid | 80° C. | No change |
| 10% ige HCl | 80° C. | Slight discoloration |
| 5% NaOH | 80° C. | Slight swelling |
| Pancreatin | 80° C. | No change |
| Tree resin | 80° C. | No change |
| DI water | 80° C. | No change |

### Use 2 (Basecoat for OEM Coating):

The pigment Bayferrox 120 NM (Bayer) was made into a 1:1 paste with a solvent mixture consisting of equal parts of butyl glycol (Solvadis), DPM dipropyleneglykolmonomethylether and diethyleneglycolmonoethylether, and added in an amount of 40 wt. % (relative to the proportion of solids) to the coating formulation of Example 1. Then 1% Tegokat 226 (Goldschmidt) was added. The pigmented basecoat made in this way was subsequently sprayed onto a steel sheet coated with body filler and dried for 30 minutes at 80° C.

### Coating Film Properties:

The test sheets have a glossy to slightly-matt surface. The scratch resistance was tested by scratching the surface moderately hard to hard with a key. Thereafter, the surface only showed hardly visible marks.

### EXAMPLE 2

410.6 g 3-isocyanatopropyltriethoxysilane (Onichem) are added to 68.1 g TMP trimethylolpropane (Fluka), mixed and heated to 80° C. Then 0.2 g DBTL are added to the mixture. After approx. 30 minutes, the mixture is cooled to 60° C. and diluted directly with 815.8 g 1-methoxy-2-propanol (Solvadis). Then 1% of a 5% sulphuric acid is added to the mixture.

### Use 1: Overpainting of Commercially Clearcoated Metal Sheets

The mixture was then coated onto a test sheet having the following overall paint system: steel sheet/CDP/body filler/basecoat/clearcoat (commercial), and dried at room temperature overnight.

### Coating Film Properties:

The test sheet showed excellent steel-wool resistance and adhesion.

### Use 2: Repair System (Spot Repair):

The mixture was sprayed onto an already sanded metal sheet coated with a commercial clearcoat and dried at room temperature. The appearance of the treated surface areas was not impaired, and adhesion of the coating was excellent even after 7 h humidity test at 40° C.

### EXAMPLE 3

0.15 g dicumylperoxide are added to 20.0 g vinyltriethoxysilane (Evonik-Degussa) and the reaction mixture heated to 150° C. with simultaneous stirring (magnetic stirrer, 500 rpm). After 30 minutes' stirring, the heating is switched off and the material (which has meanwhile become viscous) left to cool to room temperature. 60 g 1-methoxy-2-propanol and 0.8 g x-Add® KR 9006 (NANO-X GmbH, A1 initiator) are added and the mixture left on the stirrer for another 5 minutes.

The material is flooded onto a polyester topcoat and dried for 20 min at 130° C. One obtains a clear, abrasion-resistant surface coating.

### EXAMPLE 4

0.15 g dicumylperoxide are added to 24.8 g 3-methacryloxypropyltrimethoxysilane (Evonik-Degussa) and the reaction mixture heated to 110° C. with simultaneous stirring (magnetic stirrer, 500 rpm). After 30 minutes' stirring, the heating is switched off and the material (which has meanwhile become viscous) left to cool to room temperature. The resultant resin is diluted with 40 g 1-methoxy-2-propanol and mixed with 4.7 g x-Add® KR 9006 (NANO-X GmbH, A1 initiator).

### EXAMPLE 5

0.50 g dicumylperoxide are added to 24.8 g 3-methacryloxypropyltrimethoxysilane (Evonik-Degussa and 30.0 g methylmethacrylate (MMA, Sigma-Aldrich) and the reaction mixture heated to 110° C. with simultaneous stirring (magnetic stirrer, 500 rpm). After 30 minutes' stirring, the heating is switched off and the material (which has meanwhile become viscous) left to cool to room temperature. The resultant resin is diluted with 80 g 1-methoxy-2-propanol and mixed with 4.5 g x-Add® KR 9006 (NANO-X GmbH, A1 initiator) and 0.1 g Byk 301 (Byk-Chemie).

### EXAMPLE 6

0.45 g dicumylperoxide are added to 24.8 g 3-methacryloxypropyltrimethoxysilane (Evonik-Degussa), 2.4 g vinyltriethoxysilane (Evonik-Degussa) and 1.30 g 2-hydroxyethylmethacrylate (2-HEMA, Sigma-Aldrich) and the reaction mixture heated to 110° C. with simultaneous stirring (magnetic stirrer, 500 rpm). After 30 minutes' stirring, the heating is switched off. After the material has cooled to 50° C., 2.0 g 3-isocyanatopropyltrimethoxysilane (ABCR) and 0.02 g dibutyltin dilaurate (DBTL) are added and the mixture stirred for another 24 hours. The resultant resin is diluted with 60 g 1-methoxy-2-propanol and mixed with 4.7 g x-Add® KR 9006 (NANO-X GmbH, A1 initiator) and 0.1 g Byk 301 (Byk-Chemie).

The materials from the above-described examples were sprayed in each case onto a white basecoat and dried for 20 minutes at 130° C. One obtains a clear, abrasion-resistant surface coating.

1-26. (canceled)

27. Method for the production of a highly abrasion-resistant vehicle paint, comprising the following steps:
a. Providing at least one organic monomer, oligomer, prepolymer or organosilane having one or more hydroxyl groups;
b. Saturating the functional groups described in a. by reacting them with 3-isocyanantoproplyltriethoxysilane or 3-isocyanatopropyltrimethoxysilane, the resulting silane having at least six SiOR groups and a molecular weight exceeding 300;
c. Absorbing the resulting macro-molecular silanes in solvent, preferably a protic or aprotic solvent, or mixtures thereof;
d. Adding reaction partners, particularly acids, Lewis acids, bases or Lewis bases;
e. Applying the vehicle paint obtained in this manner onto a substrate, and
f. Curing the coating material.

28. Method for the production of a highly abrasion-resistant vehicle paint, comprising the following steps:
a. Providing at least one organic monomer, oligomer, prepolymer, or organosilane having one or hydroxyl groups;
b. Saturating the functional groups described in a. by reacting them with 3-isocyanantoproplyltriethoxysilane or 3-isocyanatopropyltrimethoxysilane, the resulting silane having at least six SiOR groups and a molecular weight exceeding 300;
c. Adding additives to the macromolecular silanes formed;
d. Processing the product as powder clearcoat.

29. Method according to claim 27, wherein, for a stoichiometric reaction, the corresponding groups are hydroxyl and isocyanate.

30. Method according to claim 27, wherein the monomers, oligomers or prepolymers are functionalized hydrocarbons, fluorinated hydrocarbons, polyesters, polyethers, polyurethanes, polyamides, polyanilines, polyimides, polyphenols, polysulfamides, imide, polyacrylate, polyurethane acrylate, polyester acrylate, thiols, polyether acrylates, polyester acrylates, aminofunctional acrylates, phenols, phenol resins, melamine or methacrylates.

31. Method according to claim 27, wherein pigments are added to the vehicle paint prior to its application.

32. Method according to claim 27, wherein, prior to application of the vehicle paint, organic or inorganic UV absorbers, dulling agents, wetting or dispersing agents, HALS stabilizers, free-radical scavengers, antifoaming agents, biocides, preserving agents, inorganic or organic fillers, fluorinated carbon particles or waxes are added.

33. Method according to claim 28, wherein, in step c., organic or inorganic UV absorbers, dulling agents, wetting or dispersing agents, HALS stabilizers, free-radical scavengers, antifoaming agents, biocides, preserving agents, inorganic or organic fillers, fluorinated carbon particles or waxes are added as additives.

34. Method according to claim 27, wherein the molecular weight of the silane(s) is greater than 300, preferably greater than 500, and most preferably greater than 1,000.

35. Method according to claim 27, wherein the vapor pressure of the silane(s) is less than 2, preferably less than 1 and most preferably less than 0.5 hPa at 20° C.

36. Method according to claim 27, wherein the silane(s) are inorganically pre-crosslinked to a maximum extent of 5%, preferably to a maximum extent of 1% and most preferably not at all.

37. Method according to claim 27, wherein up to 20%, preferably 0.5 to 50%, Lewis acids or Lewis bases are used as reaction partners, especially in the form of complexes or salts of transition metals, or of transition metal particles, preferably micro- or nanoparticles.

38. Method according to claim 37, Wherein the complexes, salts or particles of transition metals are complexes of titanium, aluminum, tin or zirconium.

39. Method according to claim 27, wherein, as solvent in step c., alcohols, acetates, ethers, low-molecular silanes or metal alkoxides, in particular zirconium butylate, aluminum butylate or titanium butylate, are used as reactive thinner.

40. Method according to claim 27, wherein
the coating material is applied to a substrate by a wet-chemical process, in particular by spraying, dipping, flooding, rolling, painting, printing, spinning, knife application or otherwise by vacuum evaporation.

41. Method according to claim 28, wherein the coating material is applied to a substrate by powder coating.

42. Method according to claim 40, wherein the substrate consists of metal, plastics, ceramics, paint, rubber, glass or composite materials.

43. Method according to claim 40, wherein, following application, the coating material is cured at temperatures ranging from room temperature to 1,200° C., preferably from room temperature to 250° C., curing being effected preferably by heat, microwave radiation or UV radiation.

44. Vehicle paint produced by a method according to claim 27.

45. Use of the vehicle paint according to claim 44 as clearcoat (topcoat), pigmented coat (basecoat), body-filler coat, repair coat or powder coat for vehicle bodies, in particular automobile or motorcycle bodies, vehicle parts, in particular automobile and motorcycle parts, and also fitted parts, attachments, accessories and spare parts for vehicles, in particular rims, bumpers, covers or decorative trim.
